(19) United States
(12) Patent Application Publication
(10) Pub. No.: US 2007/0234642 A1
(43) Pub. Date: Oct. 11, 2007

(54) Window Operator Having Seal

(75) Inventors: Richard L. Bildahl, Rockford, IL (US); Dean Pettit, St. John, IN (US); Thomas J. Hansel, Rockford, IL (US)

Correspondence Address: BANNER & WITCOFF, LTD., TEN SOUTH WACKER DRIVE, SUITE 3000, CHICAGO, IL, 60606, US

(73) Assignee: Newell Operating Company, Atlanta, GA (US)

(21) Appl. No.: 11/697,506

(22) Filed: Apr. 6, 2007

Related U.S. Application Data
(60) Provisional application No. 60/789,865, filed on Apr. 6, 2006.

(51) Int. Cl. E05F 11/24

(52) U.S. Cl. 49/341; 49/346; 49/345

(57) ABSTRACT

A casement window assembly has a sash window pivotally connected to a window frame. A window operator has a housing connected to the frame, including an upper and lower piece connected together. The housing has an offset countersink hole receiving a fastener. A spindle extends into the housing and has a groove therein. An arm is operably connected to the spindle and to the sash window to open and close the sash window. A resilient seal member is received within the groove in the spindle. A first gasket is positioned between the upper piece and the lower piece of the housing. A second gasket is positioned between the housing and the window frame. When the fastener is driven into the countersink hole, the housing is forced in a generally horizontal direction to compress the second gasket between the housing and the window frame.

### CROSS-REFERENCE TO RELATED APPLICATIONS

The present application is a continuation-in-part application of U.S. Provisional Patent Application No. 60/789,865, filed on Apr. 6, 2006, and claims the benefit thereof, which application is incorporated herein by reference and made a part hereof.

### TECHNICAL FIELD

The present invention generally relates to a window operator and more specifically, to a sealing configuration for the window operator.

### BACKGROUND OF THE INVENTION

Window assemblies are well-known and are marketed in several different forms. In one type of popular window assembly, a casement window assembly has a window pivotally supported within a window frame. A window operator is connected between the window and the frame, providing structure for allowing pivotal movement of the window relative the frame, thus moving the window assembly between the open and closed configurations.

Window operators may differ in numerous ways, but generally have a housing, a spindle assembly, a crank handle, and at least one arm structure. These components are operably connected such that the casement window can be opened and closed.

One problem associated with window operators is their susceptibility to penetration by the outdoor elements. For example, rainwater or other moisture from outside the building structure can travel through certain of the channels and spaces defined within the operator. If unchecked, the moisture can proceed past the spindle and handle and into the interior room of the building structure. This moisture can then drip down the interior wall below the window. Grease seals have been employed around the spindle but have proved to be less reliable. Accordingly, while window operators provide a number of advantageous features, they nevertheless have certain limitations. The present invention seeks to overcome certain of these limitations and other drawbacks of the prior art, and to provide new features not heretofore available.

### SUMMARY OF THE INVENTION

The present disclosure relates to an operator for a casement window assembly having a window pivotally connected to a window frame.

According to one aspect, a window operator for a casement window assembly is provided. The window assembly has a sash window pivotally connected to a window frame. The operator includes a housing, a spindle, an arm, and a resilient seal member. The housing is adapted to be connected to the window frame and has an internal cavity and an aperture defining an inner surface. The spindle extends into the aperture of the housing and has a distal end, an intermediate portion, and a proximal end. The proximal end is adapted to be manipulated by a user to rotate the spindle, and the intermediate portion has a groove therein. The arm is operably connected to the distal end of the spindle and is adapted to be connected to the sash window, such that the arm is moveable by rotation of the spindle to open and close the sash window. The seal member is connected to the spindle, such that the seal member is received within the groove and is positioned between the spindle and the inner surface.

According to another aspect, the housing has a generally horizontal base having an offset countersink hole adapted to receive a fastener to connect the base to the window frame. A gasket engages an outer surface of the housing and is adapted to be positioned between the housing and the window frame. When the fastener is driven into the offset countersink hole, the housing is forced in a generally horizontal direction to compress the gasket between the housing and the window frame.

According to a further aspect, the housing includes an upper piece and a lower piece connected by a press-fit connection to form the housing. The upper piece has the aperture therein, and the lower piece has a plurality of holes therethrough, each of the holes adapted to receive a fastener therethrough to connect the housing to the window frame. One of the upper piece and the lower piece has a receptacle and the other of the upper piece and the lower piece has a projection. The post is received within the receptacle with an interference fit to secure the press fit connection. A gasket is positioned and compressed between the upper piece and the lower piece.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of a casement window assembly having a window operator, depicting a sash window in an open position relative the frame and an operator assembly in an extended arrangement;

FIG. 2 is a top plan view of a portion of a window operator as is shown in FIG. 1;

FIG. 3 is a partial cross-sectional view of a window operator of the present invention, showing detail of a spindle and a resilient seal member;

FIG. 4 are perspective and exploded views of the spindle and the resilient seal member of the present invention;

FIG. 5 is a partial perspective view of the window operator of FIG. 3;

FIG. 6 is an underside view of the window operator of FIG. 5;

FIG. 7 is a partial cross-sectional view of the window operator of FIG. 5;

FIG. 8 is an exploded perspective view of a further embodiment of a window operator;

FIG. 9 is a perspective view of the window operator of FIG. 8 in an assembled condition;

FIG. 10 is a perspective view of the window operator of FIG. 8 and a gasket ready to be placed on the operator;

FIG. 11 is a perspective view of the operator and gasket of FIG. 10 in an assembled condition;

FIG. 12 is a perspective view of the operator of FIGS. 8-11 installed in a window frame; and

FIG. 13 is a partial cross-sectional view of the operator and window frame of FIG. 12.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

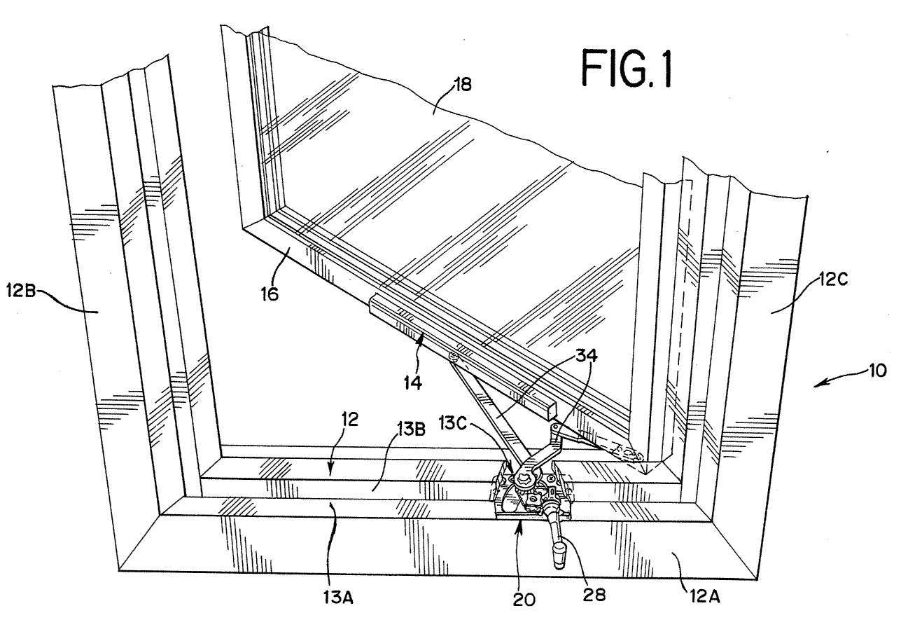

FIG. 1 shows a casement window assembly 10, which includes a jamb frame assembly 12, or window frame, and an inner window assembly 14, or sash window. The window assembly 14 is formed of a sash window frame 16 bordering a glass pane 18. The inner window assembly 14 and jamb frame assembly 12 are secured by hinged connection (not shown), such that the window 14 is moveable between an open and closed configuration relative the frame assembly 12 by pivotal movement of the inner window assembly 14. FIG. 1 depicts the window assembly 10 with the inner window assembly 14 pivoted into the open configuration relative the frame 12. The window frame 12 has four jambs 12A, 12B, 12C, and 12D (not shown). In the window frame 12 shown in FIG. 1, the lower horizontal jamb 12A has a generally horizontal surface 13A, a generally vertical surface 13B, and a slot 13C therein. In the frame 12 illustrated, the slot 13C is defined within the vertical surface 13B. It is understood that the features of the different embodiments of the invention can be utilized in various combinations to form an operator of the present invention.

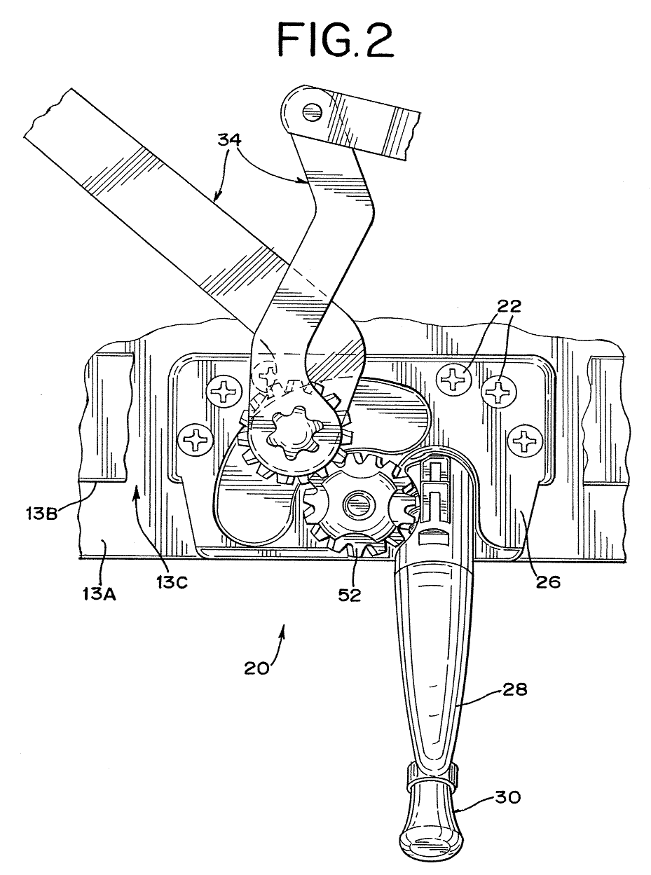

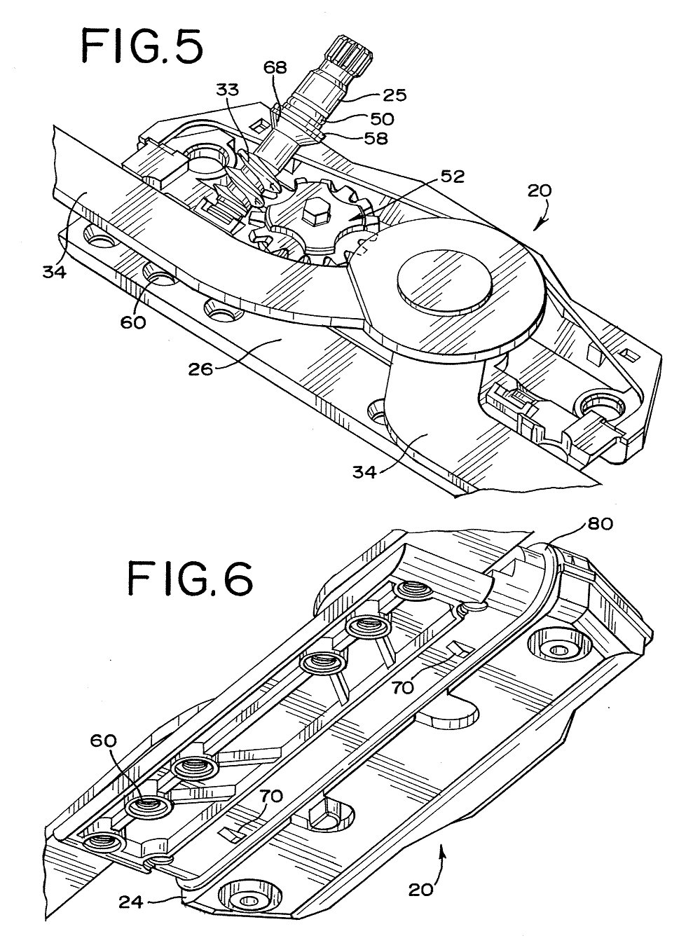

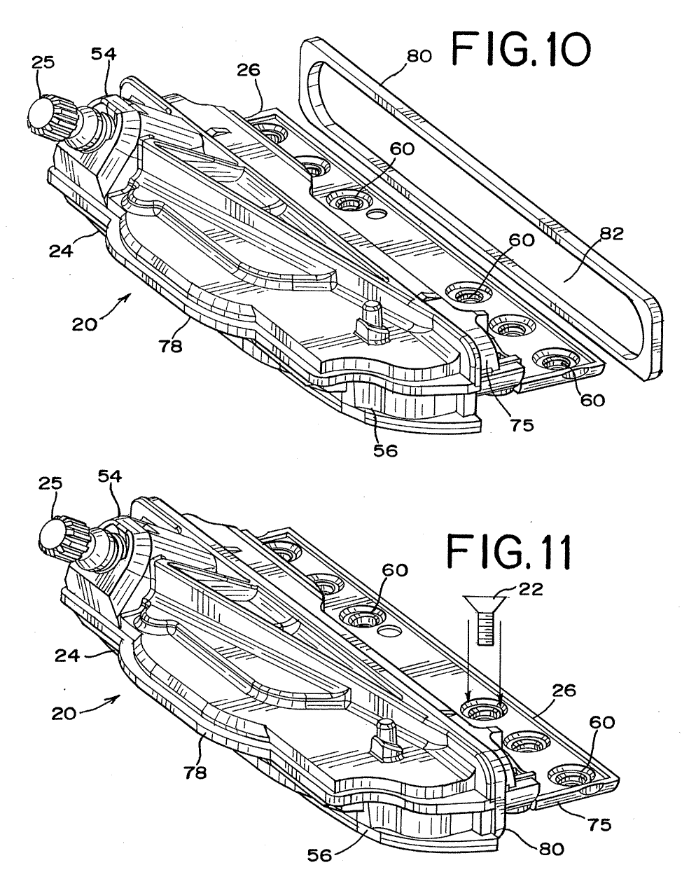

An operator assembly 20, or window operator 20, is secured in position between the window frame 12 and the inner window assembly 14 and provides control of the window assembly movable between the open and closed configurations. Three general embodiments of the operator assembly 20 are disclosed herein. One embodiment is shown in FIGS. 2-4, another embodiment is shown in FIGS. 5-7, and a further embodiment is shown in FIGS. 8-13. The operator assemblies 20 of all three embodiments are generally similar, having many elements and features in common, and similar elements are referred to with identical reference numbers for all three embodiments.

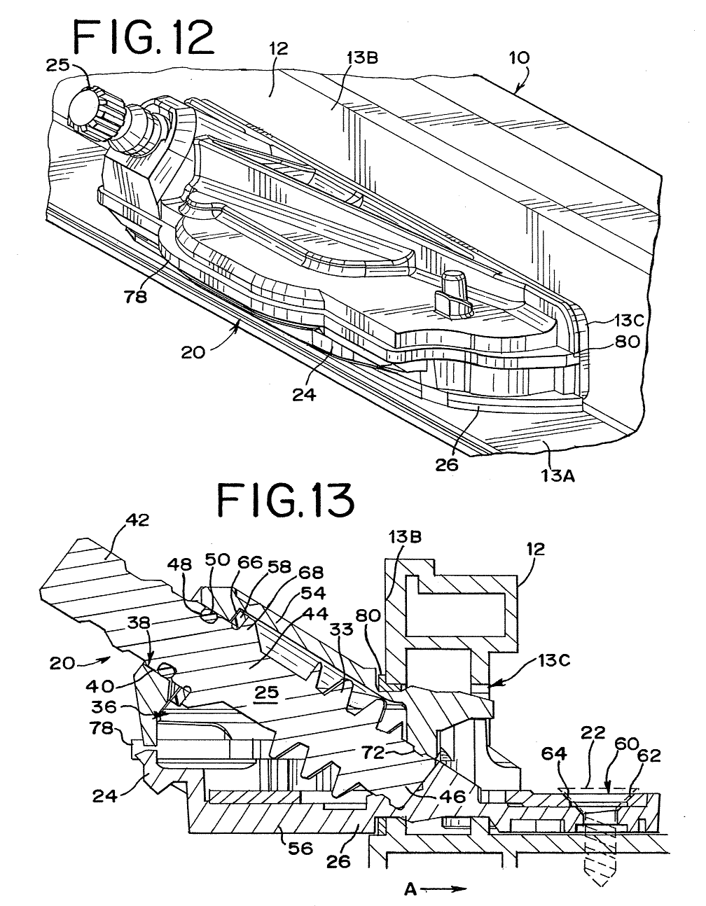

With reference to FIGS. 2-13, the operator assembly 20 generally includes a housing 24, a spindle assembly 25, a handle 28, and at least one arm 34. The embodiments illustrated contain a plurality of arms 34. In one exemplary embodiment, as is compatible with the structure of popular casement window assemblies in the market, the operator assembly 20 is secured into position by fasteners 22 securing the housing 24 of the assembly 20 to the window frame assembly 12. In the embodiments shown in the FIGS., the fasteners 22 pass through the base 26 of the housing 24 of the operator assembly 20, and pass into the frame assembly 12. As the base 26 of the operator assembly 20 is secured to the frame assembly 12, the base 26 provides secure leverage for forcing the window assembly 14 to the open or closed position, which is controlled by a user manipulating the handle 28, preferably at a grasping portion or knob 30. In some embodiments, as shown in FIGS. 2 and 12, the base 26 of the housing 24 is mounted on the horizontal surface 13A of the lower horizontal jamb 12A of the window frame 12, and a portion of the operator assembly 20, including a portion of the housing 24, is received in the slot 13C. As further shown in FIGS. 1 and 2, the arms 34 are operably connected between the window frame 12 and sash window 14 as is known. The arms 34 are operably connected to the spindle 25 and adapted to be connected to the sash window 14, wherein the arms 34 are moveable by rotation of the spindle 25 to open and close the sash window 14, as is described more fully below.

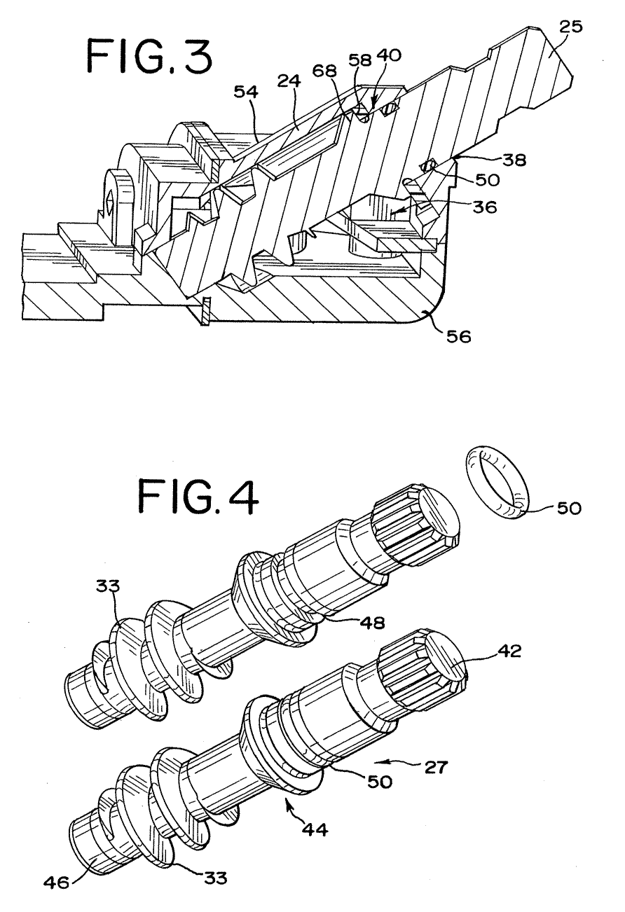

The housing 24 generally is connected to the window frame 12. The housing 24 has an internal cavity 36 designed to protect the components of the operator assembly 20 and frame assembly 12 from outside elements and foreign substances. The housing 24 has an aperture 38 designed to allow a portion of the spindle 25 to pass into the housing 24. The aperture 38 defines an inner surface 40 of the housing 24 and is dimensioned to be in close proximity to the spindle 25 of the operator assembly 20. As can be appreciated from FIG. 3, the inner surface 40 is generally annular and extends from an outer portion of the housing into the internal cavity 36.

In some exemplary embodiments, as illustrated in FIGS. 3, 7, and 8-13 the housing 24 has a two-piece construction, having a first piece 54 and a second piece 56. In the embodiments shown in FIGS. 3 and 7-13, the first piece 54 is an upper piece, located above the second piece 56, which is a lower piece. In the embodiment shown, the upper piece 54 functions to encase the internal components of the operator assembly 20 and has the aperture 38 extending therethrough, and the lower piece 56 forms the base 26 of the housing 24 and includes one or more holes 23 for fasteners 22 to pass through. The upper housing piece 54 additionally defines a shoulder 66 generally adjacent the aperture 38. The shoulder 66 faces into the internal cavity 36.

The pieces 54, 56 are connected by a press-fit connection between the two pieces. In one exemplary embodiment, illustrated in FIGS. 8-13, the press-fit connection is secured, at least in part, by engagement of complementarily-shaped structures 74, 76 located on the two pieces 54, 56. Thus, the housing 24 thus has cooperative structures for attaching the housing pieces 54, 56 together. As shown in FIG. 8, the upper piece 54 has receptacles 74 defined by tubular projections depending from the underside of the upper piece 54. The lower piece 56 has complementarily-shaped posts 76 projecting upward from the lower piece 56. The posts 76 are received in the receptacles 74 with an interference fit to secure the press-fit connection. It is understood that the orientation of the posts 76 and receptacles 74 can be altered, and it is considered that one of the pieces 54, 56 has at least one receptacle 74 and the other of the pieces 56, 54 has at least one complementary post 76. Additionally, the orientation of the posts 76 and receptacles 74 can be mixed, with each piece 54, 56 containing both posts 76 and receptacles 74 in complementary arrangement. It is also understood that each of the two housing pieces 54, 56 may not be a single, integral piece, and may contain several pieces connected together. It is further understood that the two housing pieces 54, 56 may not be oriented as readily-identifiable upper and lower pieces, as in the embodiment described above. In other embodiments, the two housing pieces 54, 56 may be left-right pieces, or may be more complex in their arrangement and orientation.

In the exemplary embodiments illustrated in FIGS. 6-7 and 8-13, a sealing gasket 80 is located between the housing 24 and the window frame 12 to prevent penetration of contaminants into the operator assembly 20. As shown, the gasket 80 defines an opening 82, and a portion of the housing 24 extends through the opening 82. In other words, the gasket 80 surrounds a portion of the housing 24, including a portion of the first piece 54 and a portion of the second piece 56. When the housing 24 is mounted on the window frame 12, the gasket 80 surrounds the slot 13C in the window frame 12 to also prevent penetration of contaminants into the slot 13C. The gasket 80 is compressed between the housing 24 and the window frame 12, as shown in FIGS. 12 and 13 and described in more detail below. As shown in FIG. 6, in some embodiments, the housing 24 may include clips 70 on the bottom surface thereof, which engage the window frame 12 to help create such compression.

In the exemplary embodiment illustrated in FIGS. 8-13, a base-cover gasket 78 is positioned between the two pieces 54, 56 to seal the interior of the housing 24 and prevent contaminants from penetrating the seal between the two pieces 54, 56. The base-cover gasket 78 has a slit 77 therein and the upper piece 54 has a protrusion 79 that is received in the slit 77 to assist in aligning and securing the base-cover gasket 78 in place, as shown in FIG. 8. In some embodiments, this gasket 78 is designed to be easily verified by sight and/or touch, unlike previous seals, which are verified by potentially-faulty automated processes. For example, the gasket 78 may be designed to extend a small distance outward of the surface of the housing 24 to allow verification by sight and/or touch, as illustrated in FIGS. 9-13. It is further understood that the sealing gasket 80 can also be similarly verified. Additionally, the base-cover gasket 78 may have two sealing tabs 75 extending from the edges of the gasket 78. The tabs 75 define cut-out portions at the ends of the gasket 78. These tabs 75 “interlock” with the sealing gasket 80 located between the housing 24 and the window frame 12 to prevent seepage of fluids into the interior of the housing 24 through capillary action. To accomplish this interlocking, the cut-out portions of the tabs 75 are received within the opening 82 defined by the sealing gasket 80 and contact the inner edge of the sealing gasket 80, as illustrated in FIG. 11.

The spindle 25 of the window operator 20 is contained in the housing 24. As shown in FIGS. 3 and 4, the spindle 25 generally includes a shaft-like member 27, having a distal end 42, an intermediate portion 44, and a proximal end 46. The proximal end 46 has a worm gear portion 33 for operation of the operator arms 34. The proximal end 46 and the housing 24 may also have cooperatively dimensioned structure 72 allowing the housing 24 to grip the spindle 25, securing the spindle 25 in place while allowing the spindle 25 to rotate. This structure 72 can be formed by the upper piece 54 and the lower piece 56 during assembly of the housing 24. The distal end 42 typically has a geared structure for cooperation with the handle 28. The intermediate portion 44 of the spindle 25 has a circumferential groove 48.

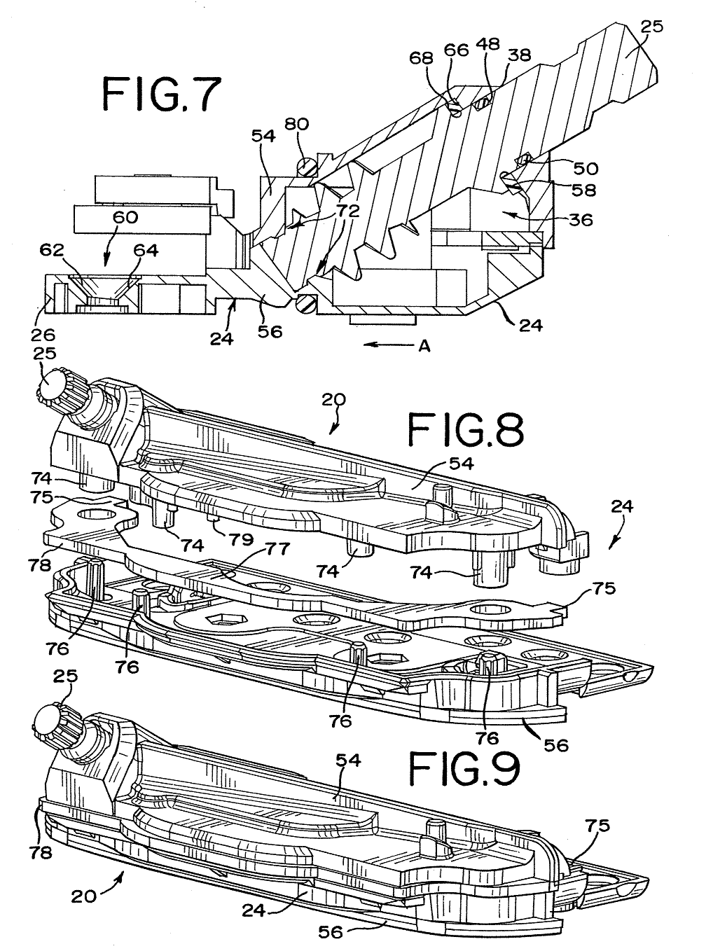

The spindle 25 further has a resilient seal member 50 connected to the spindle 25 and positioned between the spindle 25 and the housing 24 to engage an inner surface of the housing 24. In some embodiments, as shown in FIGS. 3-5, 7, and 13, the seal member 50 is designed and sized to fit within the circumferential groove 48 on the intermediate portion 44 of the spindle 25, and to engage the inner surface 40 of the aperture 38 of the housing 24. As is shown in FIGS. 3-5, 7, and 13, in some embodiments, the resilient seal member is an o-ring 50 is positioned around the spindle 25. As shown, the o-ring 50 is received in the groove 48 of the spindle 25. The o-ring 50 is dimensioned such that it has a smaller diameter than the diameter of the spindle 25. Thus, when connected to the spindle 25, the o-ring 50 is in radial tension. The spindle 25 and o-ring 50 are then mounted in the housing 24. The o-ring 50 is compressed in between the housing 24 and the groove 48 of the spindle 25, thus providing an impermeable seal. The outer portion of the o-ring 50, when connected to the spindle 25, is in full contact with the inner surface 40 of the aperture 38 of the housing 24. Thus, once assembled within the housing 24, the o-ring 50 is in radial compression. Accordingly, it is understood from FIGS. 3 and 7 that the o-ring 50 will prevent any contaminants from passing though the internal cavity 36 and out of the aperture 38. It is understood that other types of seal members could be used.

A second resilient seal member 58 is fitted circumferentially around the intermediate portion 44 of the spindle 25. In one embodiment, this second seal member 58 is a water seal gasket 58. The spindle 25 has a lip 68 extending from the intermediate portion 44. The water seal gasket 58, when surrounding the spindle 25, is seated against a surface of the internal cavity 36 of the housing 24, such as the shoulder 66 of the first housing segment 54. The compression of the water gasket seal 58 provides an additional impermeable seal surrounding the spindle 25. The seal is desired to prevent the transfer of moisture through the window operator assembly 20.

The handle 28 is mechanically engaged with the distal end 42 of the spindle 25 (FIG. 2), such that rotation of the knob 30 and handle 28 by a user translates to rotation of the spindle 25. The operable connection of the spindle 25 with the operator arms 34 results in a user's ability to open and close the sash window 14. Whatever the detailed structure and operable connections employed for transferring movement of the handle 28 into movement of the operator arms 34, the general result is for rotation of the handle 28 to move the operator arms 34 to open and close the casement window assembly 10. In the embodiments shown, a user rotating the handle 28, such as by using the knob 30, results in the spindle 25 rotating which, in turn, rotates the gears 52 of the operator assembly 20 via engagement with the worm gear portion 33. The rotating gears 52 are operably connected to the operator arms 34, such that the rotation of the handle 28 results in motion of the operator arms 34, creating movement of the sash window 14. Further, the inclusion of the resilient seal member 50 in the aperture 38 of the housing 24 and the resilient seal member 58 in the cavity 36 of the housing 24 prevents moisture from entering the operator 20 or leaking from the handle portion 28. The structure resulting from this method of assembly provides a spindle 25 in which the resilient seal members 50, 58 form an impermeable seal with the housing 24. This provides a clean, reliable, and predictable solution to the problems of moisture entering the housing assembly and migrating past the aperture 38 of the housing 24 of the operator assembly 20.

In the embodiment shown in FIG. 7 the housing 24 has a first (upper) housing piece 54 and a second (lower) housing piece 56. The second housing piece 56 is attached to the window frame 12 and secures the window operator assembly 20. The base 26 of the second housing piece 56 has a mounting screw hole 60 that has an offset countersink configuration. In other words, a first segment 62 of the surface defining the offset countersink hole 60 is inclined at a greater angle than a second segment 64 of the defining surface. A fastener 22, typically in the form of a screw, is inserted in the offset countersink screw hole 60 and is tightened to secure the housing 24 to the window frame 12. As can be understood from FIGS. 7 and 13, the screw will engage the first segment 62 of the hole 60 more fully than the second segment 64 of the hole 60. As a result of the angle of the offset hole 60, the first housing piece 54 and the second housing piece 56 will be forced in a generally horizontal direction (to the left in FIG. 7 and to the right in FIG. 13, indicated by arrow A) when the screw fastener 22 is tightened. The movement will cause the housing 24 to press against the gasket 80, resulting in compression of the gasket 80 between the housing 24 and the bottom jamb 12A of the window frame 12, and achieving superior sealing qualities. The compression of the gasket 80 between the housing 24 and the window frame 12 is illustrated in FIG. 13 and can also be appreciated from FIG. 12. It is understood that in one exemplary embodiment, the housing piece 56 moves in a generally horizontal direction. The housing 24 can be configured to move in different directions to compress a gasket positioned in different configurations. In the embodiment illustrated in FIGS. 8-13, the housing 24 has a plurality of offset countersink screw holes 60, each adapted to receive a fastener and functioning in the manner described above to shift the housing 24 and compress the gasket 80. It is understood that the gasket 80 can be dimensioned in varying sizes wherein planar surfaces of the gasket 80 can be larger if desired to accommodate differently sized openings in the window frame. It is also understood that in the embodiments disclosed herein, the operator may further have a cover member positioned over the entire operator assembly and having an opening the handle to pass therethrough to be accessible to a user. The cover member can be designed having visually pleasing aesthetic features.

The multiple sealing features of the operator of the present invention provide significant advantages over the previous operators. Using the different sealing members eliminates the need for injecting grease into the operator as a sealing member. This leads to a much cleaner assembly. The various sealing members such as the o-ring 50 and the based cover and sealing gaskets 78, 80 prevent moisture or other contaminants from passing from the outside environment, into the operator structure and into an interior of a room where the operator is mounted. It is understood that the operator can be equipped with all of the sealing members disclosed or only a portion thereof as desired by a user.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the spirit or central characteristics thereof. The present examples and embodiments, therefore, are to be considered in all respects as illustrative and not restrictive, and the invention is not to be limited to the details given herein. The terms “first,” “second,” “horizontal,” “vertical,” “upper,” “lower,” etc., as used herein, are intended for illustrative purposes only and do not limit the embodiments in any way. Additionally, the term “plurality,” as used herein, indicates any number greater than one, either disjunctively or conjunctively, as necessary, up to an infinite number. Accordingly, while the specific embodiments have been illustrated and described, numerous modifications come to mind without significantly departing from the spirit of the invention and the scope of protection is only limited by the scope of the accompanying claims.

What is claimed is:

1. A window operator for a casement window assembly having a sash window pivotally connected to a window frame, the window operator comprising:
a housing adapted to be connected to the window frame;
a spindle extending into the housing;
an arm operably connected to the spindle and adapted to be connected to the sash window, wherein the arm is moveable by rotation of the spindle and is adapted to open and close the sash window; and
a resilient seal member connected to the spindle, wherein the seal member engages an inner surface of the housing.

2. The window operator of claim 1, wherein the spindle has a groove therein, and the seal member is received within the groove.

3. The operator assembly of claim 2, wherein the spindle has a distal end, an intermediate portion, and a proximal end, the distal end operably connected to the arm, the proximal end adapted to be manipulated by a user to rotate the spindle, and the intermediate portion having said groove therein.

4. The window operator of claim 1, wherein the housing has an internal cavity and an aperture, wherein the spindle extends into the housing through the aperture, the aperture defining said inner surface engaged by the seal member.

5. The operator assembly of claim 4, further comprising a second resilient seal member, the second seal member engaging the spindle and a surface of the internal cavity.

6. The operator assembly of claim 5, wherein the spindle has a lip extending therefrom and the second seal member is positioned between the lip and the internal cavity surface.

7. The operator assembly of claim 1, wherein the resilient seal member is an o-ring.

8. A window operator for a casement window assembly having a sash window pivotally connected to a window frame, the window operator comprising:
a housing adapted to be connected to the window frame, the housing having an internal cavity and an aperture defining an inner surface;
a spindle extending into the aperture of the housing, the spindle having a distal end, an intermediate portion, and a proximal end, the proximal end adapted to be manipulated by a user to rotate the spindle, and the intermediate portion having a groove therein;
an arm operably connected to the distal end of the spindle and adapted to be connected to the sash window, wherein the arm is moveable by rotation of the spindle and is adapted to open and close the sash window; and
a resilient seal member connected to the spindle, wherein the seal member is received within the groove and is positioned between the spindle and the inner surface.

9. The operator assembly of claim 8, further comprising a second resilient seal member, the second seal member engaging the spindle and a surface of the internal cavity.

10. The operator assembly of claim 9, wherein the spindle has a lip extending therefrom and the second seal member is positioned between the lip and the internal cavity surface.

11. A window operator for a casement window assembly having a sash window pivotally connected to a window frame, the window operator comprising:
a housing adapted to be connected to the window frame, the housing having a generally horizontal base having an offset countersink hole adapted to receive a fastener to connect the base to the window frame;
a spindle extending into the housing;
an arm operably connected to the spindle and adapted to be connected to the sash window, wherein the arm is moveable by rotation of the spindle and is adapted to open and close the sash window; and
a gasket engaging an outer surface of the housing and adapted to be positioned between the housing and the window frame, wherein when the fastener is driven into the countersink hole, the housing is forced to compress the gasket between the housing and the window frame.

12. The window operator of claim 11, wherein the window frame comprises a horizontal surface and a vertical surface, the vertical surface having a slot therein, and wherein the base of the housing is adapted to be connected to the horizontal surface and a portion of the operator is adapted to be received in the slot, the gasket adapted to be positioned around the slot and positioned between the housing and the vertical surface.

13. The window operator of claim 11, wherein the housing comprises a first piece and a second piece connected together, and the gasket surrounds a portion of the first piece and a portion of the second piece.

14. The window operator of claim 13, further comprising a second gasket positioned between the first piece and the second piece.

15. The window operator of claim 14, wherein the second gasket comprises a tab that extends into an opening defined by the first gasket.

16. A window operator for a casement window assembly having a sash window pivotally connected to a window frame, the window operator comprising:
a housing adapted to be connected to the window frame, the housing comprising a first piece and a second piece connected by a press-fit connection to form the housing;
a spindle extending into the housing; and
an arm operably connected to the spindle and adapted to be connected to the sash window, wherein the arm is moveable by rotation of the spindle and is adapted to open and close the sash window.

17. The window operator of claim 16, wherein the first housing piece has an aperture therein, the spindle extending into the housing through the aperture.

18. The window operator of claim 16, wherein the second housing piece has a plurality of holes therethrough, each of the holes adapted to receive a fastener therethrough to connect the housing to the window frame.

19. The window operator of claim 16, wherein the first piece is an upper piece and the second piece is a lower piece located generally below the upper piece.

20. The window operator of claim 16, wherein the first piece has a plurality of receptacles and the second piece has a plurality of posts, wherein each post is received within one of the receptacles with an interference fit to secure the press-fit connection.

21. The window operator of claim 16, further comprising a gasket positioned between the first piece and the second piece.

22. The window operator of claim 21, wherein the first piece has a protrusion and the gasket has a slit therein, and the protrusion is received within the slit.

23. The window operator of claim 16, further comprising a second gasket engaging an outer surface of the housing, the second gasket surrounding a portion of the first piece and a portion of the second piece, the second gasket further adapted to be positioned between the housing and the window frame.

24. The window operator of claim 23, wherein the first gasket has a tab that extends into an opening defined by the second gasket.

25. A window operator for a casement window assembly having a sash window pivotally connected to a window frame, the window operator comprising:
a housing adapted to be connected to the window frame, the housing comprising an upper piece and a lower piece connected by a press-fit connection to form the housing, the upper piece having an aperture therein, and the lower piece having a plurality of holes therethrough, each of the holes adapted to receive a fastener therethrough to connect the housing to the window frame, wherein one of the upper piece and the lower piece has a receptacle and the other of the upper piece and the lower piece has a projection, the post received within the receptacle with an interference fit to secure the press fit connection;
a spindle extending into the housing through the aperture;
an arm operably connected to the spindle and adapted to be connected to the sash window, wherein the arm is moveable by rotation of the spindle and is adapted to open and close the sash window; and
a gasket positioned between the upper piece and the lower piece.

26. A window operator for a casement window assembly having a sash window pivotally connected to a window frame, the window operator comprising:
a housing adapted to be connected to the window frame, the housing comprising an upper piece and a lower piece connected by a press-fit connection to form the housing, the upper piece having an aperture therein, and the lower piece having an offset countersink hole adapted to receive a fastener to connect the base to the window frame;
a spindle extending into the aperture of the housing, the spindle having a distal end, an intermediate portion, and a proximal end, the proximal end adapted to be manipulated by a user to rotate the spindle, and the intermediate portion having a groove therein;
an arm operably connected to the distal end of the spindle and adapted to be connected to the sash window, wherein the arm is moveable by rotation of the spindle and is adapted to open and close the sash window;
a resilient seal member connected to the spindle, wherein the seal member is received within the groove;
a first gasket positioned between the upper piece and the lower piece; and
a second gasket engaging an outer surface of the housing and adapted to be positioned between the housing and the window frame, wherein when the fastener is driven into the countersink hole, the housing is forced in a generally horizontal direction to compress the second gasket between the housing and the window frame.
